(19) United States
(12) Patent Application Publication
(10) Pub. No.: US 2002/0084879 A1
(43) Pub. Date: Jul. 4, 2002

(54) Method of manufacturing an electrical-power transformer

(76) Inventors: Benjamin Weber, Winterberg (DE); Thomas J. Lanoue, Cary, NC (US)

Correspondence Address: Steven B. Samuels, Esq., WOODCOCK WASHBURN KURTZ, MACKIEWICZ & NORRIS LLP, One Liberty Place - 46th Floor, Philadelphia, PA, 19103, US

(21) Appl. No.: 09/752,489

(22) Filed: Dec. 29, 2000

(51) Int. Cl. H01F 5/00; H01F 27/24

(52) U.S. Cl. 336/200; 29/602.1; 29/605; 29/830

(57) ABSTRACT

A method of manufacturing an electrical-power transformer comprises forming a first and a second plurality of laminae from one or more pieces of magnetic material, and applying a corrosion-protection measure to edges of the laminae. The first plurality of laminae are stacked to form a winding leg and a first yoke after the corrosion-protection measure is applied to the edges thereof, and a phase winding is installed on the winding leg. The second plurality of laminae are stacked to form a second yoke after the corrosion-protection measure is applied to the edges thereof, and the second yoke is fixedly coupled to the winding leg.

### FIELD OF THE INVENTION

The present invention relates to the manufacture of magnetic-induction devices such as electrical-power transformers. More specifically, the present invention provides a method of manufacturing electrical-power transformers and cores therefor in an efficient and cost-effective manner.

### BACKGROUND OF THE INVENTION

Electrical-power transformers are commonly classified as being of the oil-filled or dry varieties. Oil-filled transformers typically comprise some type of tank or enclosure that houses the transformer's magnetic core. The tank is filled with oil and sealed before the transformer enters service. Hence, the core of an oil-filled transformer is immersed in oil throughout most or all of its operational life. The oil isolates the core from the atmosphere, and thereby protects the core from the effects of atmospheric corrosion.

The core of a dry-type transformer, by contrast, is usually exposed to the ambient environment. Protecting the ferromagnetic core from the effects of atmospheric corrosion is therefore a critically-important design consideration for these types of transformers. Such protection is typically achieved by applying some type of corrosion-resistant coating to the core during the manufacturing process of the transformer.

FIG. 1 depicts a dry, single-phase, shell-type transformer 10. The transformer 10 comprises a stacked core 12 (see FIG. 2). The core 12 includes a upper yoke 14, a lower yoke 16, a winding leg 18, and first and second outer legs 20, 21. The upper and lower yokes 14, 16 are formed from a plurality of laminae 25. The laminae 25 are superposed, i.e., stacked, to a predetermined depth and bound together by a suitable means such as adhesive to form the upper and lower yokes 14, 16.

The winding leg 18 is formed from a plurality of laminae 26. The laminae 26 are stacked to a predetermined depth and bound together to form the winding leg 18. The first and second outer legs 20, 21 are formed from a plurality of laminae 27. The laminae 27 are stacked to a predetermined depth and bound together to form the outer legs 20, 21.

Opposing ends of the first and second outer legs 20, 21 are fixedly coupled to ends of the upper and lower yokes 14, 16, as shown in FIGS. 1 and 2. Opposing ends of the winding leg 18 are fixedly coupled to the approximate mid-points of the upper and lower yokes 14, 16. A coil 31 comprising primary and secondary phase windings 31a, 31b is positioned around the winding leg 18 (see FIG. 1).

A conventional manufacturing process for a transformer such as the transformer 10 is typically performed in the following manner. The laminae 25, 26, 27 are formed by cutting, punching, or shearing the laminae 25, 26, 27 from a long, narrow strip of suitable magnetic material such as textured silicon steel or an amorphous alloy. The strip of magnetic material (hereinafter referred to as a “material strip”) is typically cut from a larger sheet of magnetic material. An inorganic, corrosion-resistant coating is usually applied to this sheet during its manufacture.

The laminae 25 that form the lower yoke 16 are stacked and bound as previously described. In addition, the laminae 26, 27 are stacked and bound in the previously-described manner to form the winding leg 18 the outer legs 21, 22.

The manufacturing process for the transformer 10 is usually interrupted at this point so that a moisture-resistant coating such as epoxy-based paint can be applied to portions of the lower yoke 16, the winding leg 18, and the outer legs 21, 22. In particular, the epoxy-based paint is applied to the exposed edges of the laminae 25, 26, 27 that make up the lower yoke 16, the winding leg 18, and the outer legs 21, 22. Coating the exposed edges is necessary because these edges did not exist at the time the original corrosion-resistant coating was applied to the sheet material from which the laminae 25, 26, 27 were formed. Hence, the edges of the laminae 25, 26, 27 are not covered by any protective coating immediately after they are formed.

The epoxy-based paint is typically brushed onto the edges of the laminae 25, 26, 27 on a manual basis. The epoxy-based paint must be applied at this point in the manufacturing process because further assembly of the transformer 10 will block access to many of the surfaces that require an application of the paint. The absence of any corrosion-protection measure on the exposed surfaces on the laminae 25, 26, 27 will leave those surfaces susceptible to atmospheric corrosion. Such corrosion can cause the transformer 10 to malfunction, and can substantially reduce the service life of the transformer 10.

The primary and secondary phase windings 31a, 31b are subsequently installed on the winding leg 18. The laminae 25 that form the upper yoke 14 are then stacked and bound. The epoxy-based paint is subsequently applied to the exposed edges of the laminae 25 of the upper yoke 14. The upper yoke 14 is then fixedly coupled to the winding leg 18 and the outer legs 20, 21.

The epoxy-based paint must be applied to various portions of the core 12 at two discrete points during the conventional manufacturing process for the transformer 10, as is evident from the above discussion. This two-step application is necessary because the laminae 25, 26, 27 that form the lower yoke 16, winding leg 18, and outer legs 20, 21 must be coated prior to installation of the primary and secondary phase windings 31a, 31b. The primary and secondary phase windings 31a, 31b, however, must be installed before the upper yoke 14 can be fixedly coupled to the winding leg 18 and the outer legs 20, 21. Interrupting the core-assembly process twice during manufacture of the transformer 10 decreases the efficiency with which the manufacturing process can be performed, and thus increases the time and labor needed to manufacture the transformer 10.

Furthermore, the epoxy-based paint cannot readily be applied on an automated basis while the core 12 is being assembled. Hence, the advantages associated with automated manufacturing operations, e.g., reducing the time, costs, defects, and labor associated with the manufacturing process, cannot not easily be realized with the conventional transformer-manufacturing process described herein. Thus, a need exists for a method of manufacturing a transformer, and a core therefore, in a quicker, more efficient, and less labor-intensive manner than is currently possible using conventional manufacturing techniques.

### SUMMARY OF THE INVENTION

An object of the present invention is to provide a method of manufacturing an electrical-power transformer in an efficient and cost-effective manner. In accordance with this object, a presently-preferred method of manufacturing an electrical-power transformer comprises forming a first and a second plurality of laminae from one or more pieces of magnetic material, and applying a corrosion-protection measure to edges of the first and the second pluralities of laminae. The presently-preferred method further comprises stacking the first plurality of laminae to form a winding leg and a first yoke after applying the corrosion-protection measure to the edges of the first plurality of laminae, and installing a phase winding on the winding leg. The presently-preferred method also comprises stacking the second plurality of laminae to form a second yoke after applying the corrosion-protection measure to the edges of the second plurality of laminae, and fixedly coupling the second yoke to the winding leg.

A further object of the present invention is to provide an efficient and cost-effective method of manufacturing a stacked core for a magnetic-induction device such as a transformer. In accordance with this object, a presently-preferred method of manufacturing a stacked core for a magnetic-induction device comprises forming a plurality of laminae from one or more pieces of magnetic material, and applying a corrosion-protection measure to edges of the laminae. The presently-preferred method also comprises stacking the laminae to form a winding leg and a first and a second yoke after applying the corrosion-protection measure.

A further object of the present invention is to provide an efficient and cost-effective method of manufacturing a wound core for a magnetic-induction device. In accordance with this object, a presently-preferred method of manufacturing a wound core for a magnetic-induction device comprises forming a strip of magnetic material from a piece of magnetic material, and applying a corrosion-protection measure to edges of the strip of magnetic material. The presently-preferred method also comprises winding the strip of magnetic material after applying the corrosion-protection measure to form a magnetic loop.

### BRIEF DESCRIPTION OF THE DRAWINGS

The foregoing summary, as well as the following detailed description of a presently-preferred method, is better understood when read in conjunction with the appended drawings. For the purpose of illustrating the invention, the drawings depict a transformer that is capable of being manufactured in accordance with the present invention. The invention is not limited, however, to use with the specific transformer disclosed in the drawings. In the drawings:

FIG. 1 is a diagrammatic elevational view of a transformer that is capable of being manufactured in accordance with the present invention;

FIG. 2 is a diagrammatic elevational view of a core of the transformer depicted in FIG. 1;

FIG. 3A is a diagrammatic plan view of a lamina used to form a yoke of the transformer core depicted in FIG. 2;

FIG. 3B is a diagrammatic perspective view of a yoke of the transformer core depicted in FIG. 2;

FIG. 4A is a diagrammatic plan view of a lamina used to form a winding leg of the transformer core depicted in FIG. 2;

FIG. 4B is a diagrammatic perspective view of a winding leg of the transformer core depicted in FIG. 2;

FIG. 5A is a diagrammatic plan view of a lamina used to form an outer leg of the transformer core depicted in FIG. 2;

FIG. 5B is a diagrammatic perspective view of an outer leg of the transformer core depicted in FIG. 2; and

FIG. 6 is a diagrammatic plan view of the lamina shown in FIG. 3A before a moisture-resistant coating is applied to edges of the lamina.

### DESCRIPTION OF PREFERRED EMBODIMENTS

The present invention provides a method for manufacturing an electrical-power transformer. The method also provides a method for manufacturing a core for a magnetic induction device such as an electrical-power transformer. A presently-preferred method is described in connection with a dry, single-phase, shell-type transformer having a stacked core. This transformer is described in detail for exemplary purposes only, as the invention is applicable to virtually any transformer configuration, including multi-phase transformers of both the core and shell type, transformers having wound cores, and oil-filled transformers. Furthermore, the invention is applicable to magnetic-induction devices other than electrical-power transformers.

The previously-described transformer 10 can be manufactured in accordance with the present invention. The present invention will be thus described in connection with the transformer 10, for convenience. Significant details regarding the construction of the transformer 10 are repeated below for clarity.

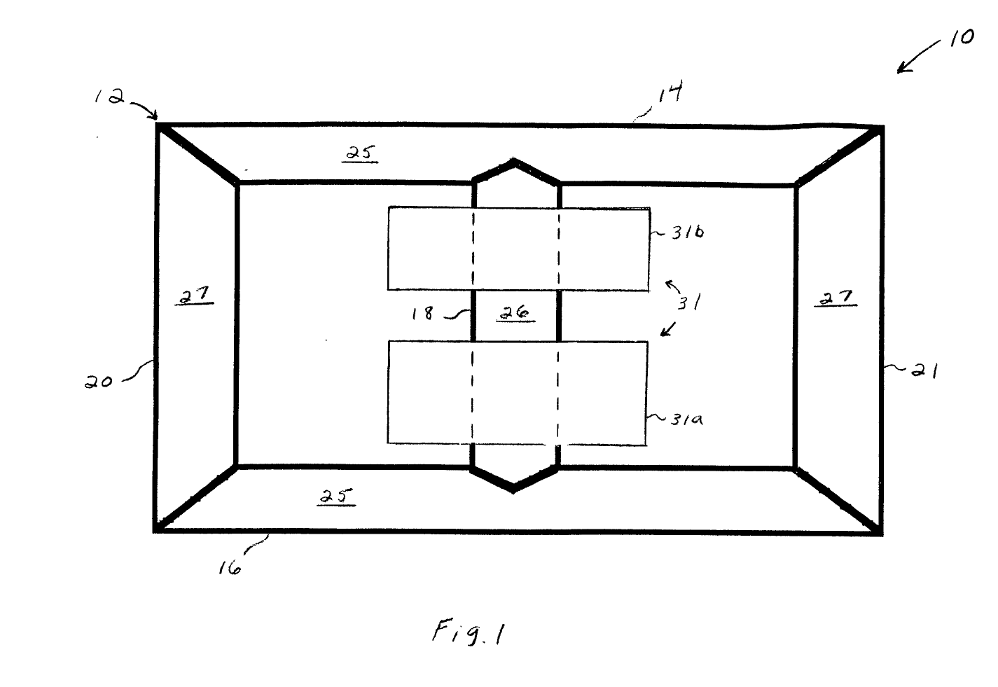

The transformer 10, and individual components thereof, are shown in FIGS. 1-6. Details of the transformer 10 in addition those shown in the figures are necessary not for an understanding of the invention, and therefore are not included in the figures.

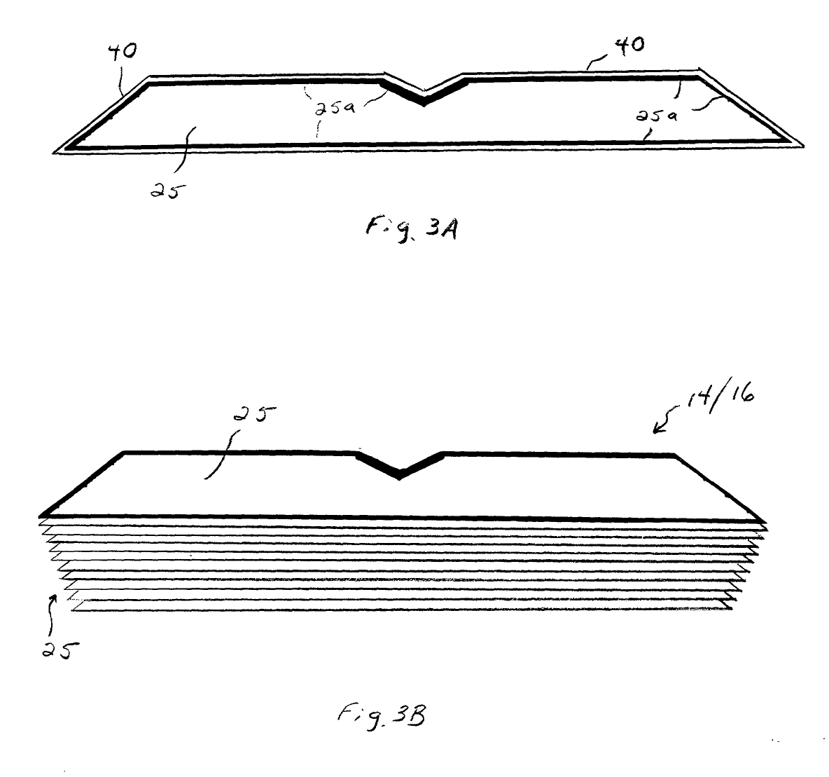

The transformer 10, as noted previously, comprises a stacked core 12. The core 12 includes a upper yoke 14, a lower yoke 16, a winding leg 18, and first and second outer legs 20, 21. The upper and lower yokes 14, 16 are formed from a plurality of laminae 25 having the shape depicted in FIG. 3A. The laminae 25 are stacked to a predetermined depth and bound together by a suitable means such as adhesive to form the upper and lower yokes 14, 16 (see FIG. 3B).

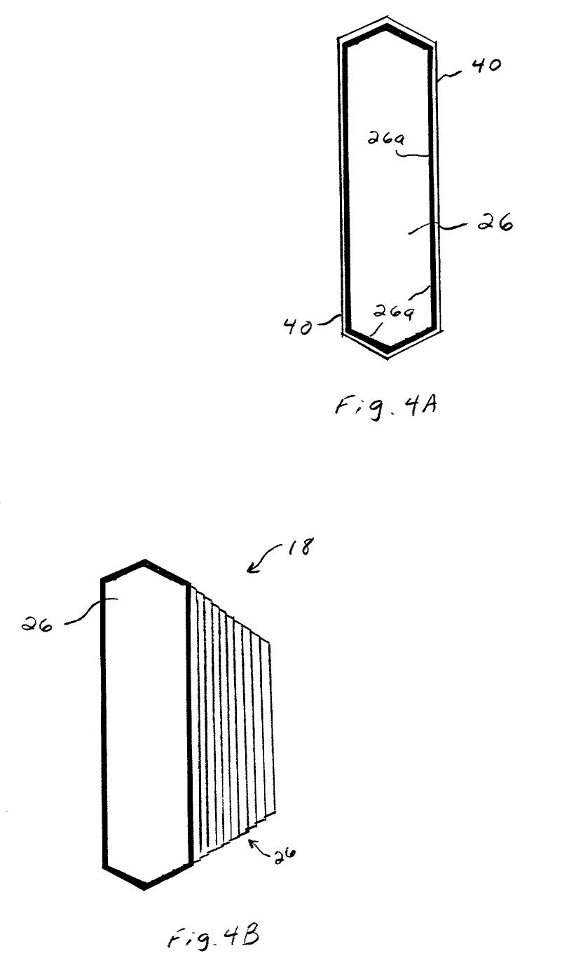

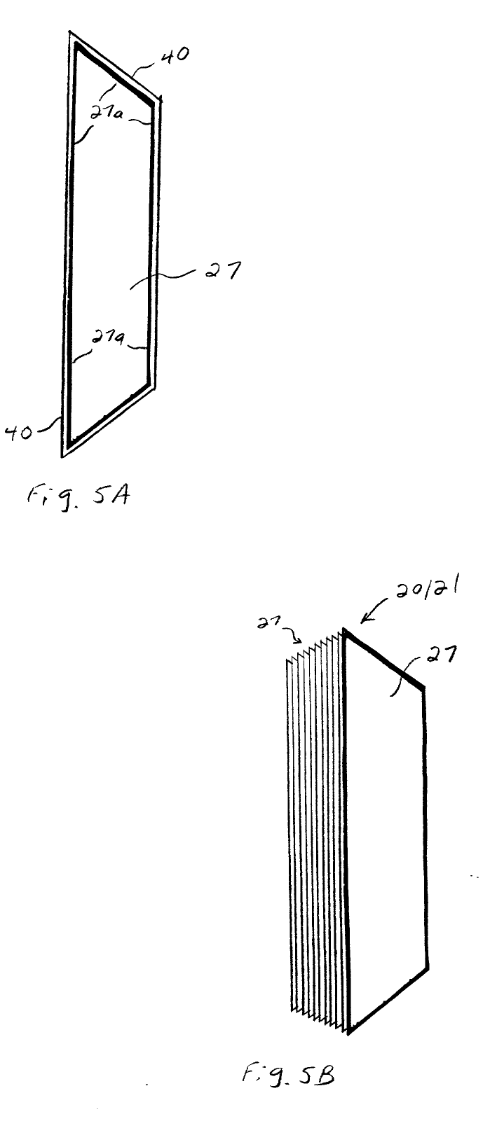

The winding leg 18 is formed from a plurality of laminae 26 having the shape depicted in FIG. 4A. The laminae 26 are stacked to a predetermined depth and bound together to form the winding leg 18 (see FIG. 4B). The first and second outer legs 20, 21 are formed from a plurality of laminae 27 having the shape depicted in FIG. 5A. The laminae 27 are stacked to a predetermined depth and bound together to form the outer legs 20, 21 (see FIG. 5B). (The spacing between the laminae 25, 26, 27 is exaggerated in FIGS. 3B, 4B, and 5B, for clarity.)

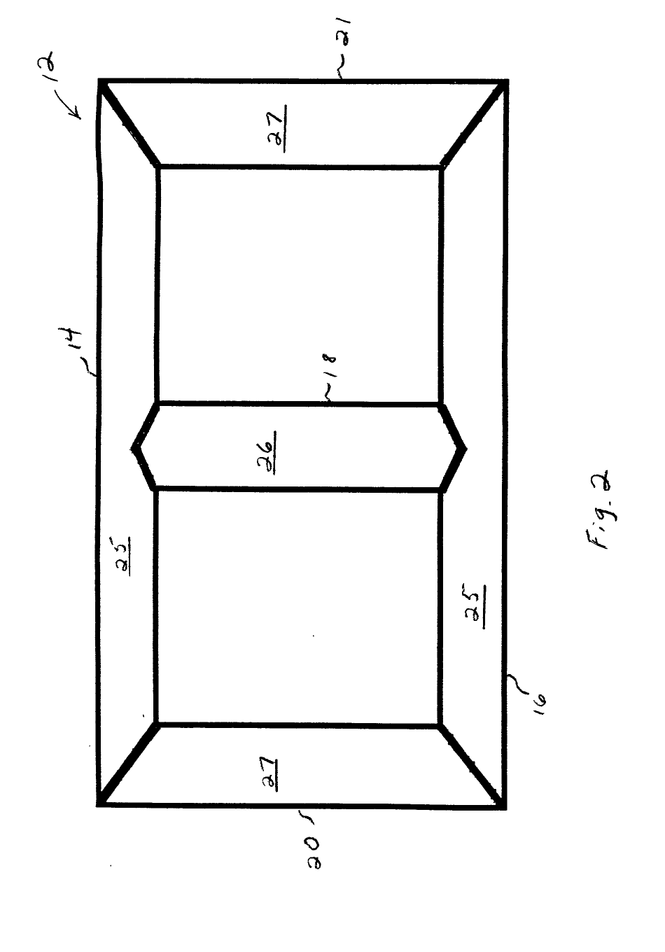

Opposing ends of the first and second outer legs 20, 21 are fixedly coupled to ends of the upper and lower yokes 14, 16, as shown in FIGS. 1 and 2. Opposing ends of the winding leg 18 are fixedly coupled to the approximate mid-points of the upper and lower yokes 14, 16. The yokes 14, 16, winding leg 18, and outer legs 20, 21 can be fixedly coupled by any suitable means such as interlocking protrusions and recesses formed along the contacting surfaces, or welding. The ends of the upper and lower yokes 14, 16, the winding leg 18, and the first and second outer legs 20, 21 are beveled to facilitate the use of miter joints. This configuration is presented for exemplary purposes only, as the upper and lower yokes 14, 16, the winding leg 18, and the first and second outer legs 20, 21 can be coupled using virtually any type of interface.

A coil 31 is positioned around the winding leg 18 (see FIG. 1). The coil 31 comprises a primary phase winding 31a and a secondary phase winding 31b. The primary phase winding 31a is adapted for connection to an alternating-current power source (not shown), and the secondary phase winding 31b is adapted for connection to a load (also not shown). The primary and secondary phase windings 31a, 31b are inductively coupled via the core 12 when the primary phase winding 31a is energized by the power source. In particular, the alternating voltage across the primary phase winding 31a sets up an alternating magnetic flux in the core 12. This flux induces an alternating voltage across the secondary phase winding 31b (and the load connected thereto). (The noted coil configuration is presented for exemplary purposes only; the invention is equally applicable to transformers comprising coils having one, or more than two windings.)

Details concerning the manufacture of the transformer 10 are as follows. The laminae 25, 26, 27 are formed from a piece of suitable magnetic material such as textured silicon steel or an amorphous alloy. In particular, the laminae 25, 26, 27 may be formed from a thin, rolled strip of magnetic material (hereinafter referred to as a “material strip”). The material strip is typically cut from a larger sheet of magnetic material, e.g., a 1.0 m (39 in.) wide, 0.30 mm (0.012 in.) thick sheet of textured silicon steel or amorphous alloy. An inorganic, corrosion-resistant coating is usually applied to both sides of the sheet before the sheet is cut into the material strips.

The laminae 25, 26, 27 are typically formed by cutting, punching, or shearing the laminae 25, 26, 27 from one or more of the material strips. Each of the laminae 25, 26, 27 thus includes newly-formed edges 25a, 26a, 27a that result from the cutting, punching, or shearing operation (see FIGS. 3A, 4A, 5A). Significantly, the edges 25a, 26a, 27a are not covered by the original corrosion-resistant coating that was applied to the sheet of magnetic material from which the material strip was formed.

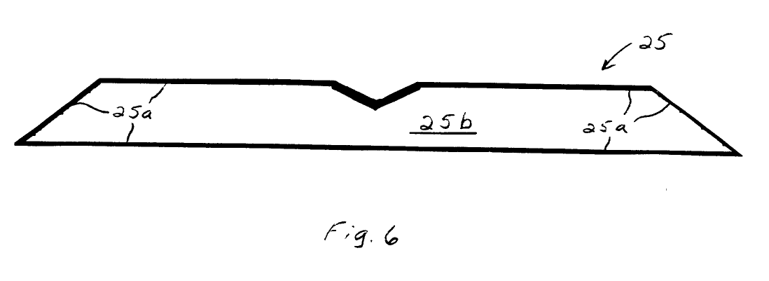

For example, FIG. 6 depicts one of the laminae 25 immediately after being formed. Sides 25b of the lamina 25 are covered by the corrosion-resistant coating that was originally applied to the sheet of magnetic material from which the lamina 25 was formed (only one of the sides 25b is visible in FIG. 4). The edges 25a of the lamina 25 are not covered by the original coating because the edges 25a did not exist at the time that coating was applied to the sheet material.

In accordance with the present invention, a corrosion-protection measure is applied to the edges 25a, 26a, 27a before the laminae 25, 26, 27 are stacked. The corrosion-protection measure can be any suitable measure that inhibits or prevents atmospheric corrosion from occurring on the 25a, 26a, 27a. The corrosion-protection measure can be, for example, a moisture-resistant coating 40 such as a epoxy-based paint. (The coating 40 is shown in FIGS. 3A, 4A, and 5A; the thickness of the coating 40 is exaggerated in those figures for clarity.)

The moisture-resistant coating 40 is preferably applied to the edges 25a, 26a, 27a on an automated basis, shortly after the corresponding laminae 25, 26, 27 have been formed. The coating 40 can be applied by a suitable means such as brushing or spraying. Applying the coating 40 at this point in the manufacturing process substantially reduces the time and labor needed to produce the transformer 10, as explained in detail below.

The core 12 is assembled following application of the moisture-resistant coating 40 to the edges 25a, 26a, 27a. In particular, the laminae 25 that form the lower yoke 16 are stacked and bound in the previously-described manner. In addition, the laminae 26, 27 are stacked and bound to form the winding leg 18 the outer legs 21, 22. The winding leg 18 the outer legs 21, 22 are then fixedly coupled to the lower yoke 16.

The primary and secondary phase windings 31a, 31b are subsequently installed on the winding leg 18. The primary and secondary phase windings 31a, 31b may be wound onto the winding leg 18. Alternatively, the primary and secondary phase windings 31a, 31b may be pre-wound, and then slid into position over the winding leg 18.

The laminae 25 that form the upper yoke 14 are subsequently stacked and bound in the previously-described manner. The upper yoke 14 is then fixedly coupled to the winding leg 18 and the outer legs 20, 21. This action completes the manufacture of the transformer 10 as shown in FIG. 1.

The method of manufacturing an electrical-power transformer provided by the present invention provides substantial advantages in relation to conventional transformer-manufacturing methods. For example, applying the moisture-resistant coating 40 to the laminae 25, 26, 27 before the stacking process substantially reduces the time and labor needed to manufacture the transformer 10, for the following reasons.

In a conventional transformer-manufacturing process, as previously explained, a moisture-resistant coating such as the coating 40 is manually applied to the edges 25a, 26a, 27a after the laminae 25, 26, 27 have been stacked. The present invention, by contrast, provides for the application of the moisture-resistant coating 40 before the assembly of the core 12 is commenced. The present invention thereby eliminates the need to apply the coating 40 after the assembly process has started. Hence, the assembly of the core 12 can proceed on an uninterrupted basis, thus yielding a more efficient manufacturing process that can be completed in less time and with less effort than a conventional process.

Furthermore, the conventional transformer-manufacturing process requires a second application of the moisture-resistant coating 40 after the upper yoke 14 has been stacked. The present invention obviates the need to apply the coating 40 at two discrete points during the manufacturing process. In fact, the formation of the laminae 25, 26, 27 and the application of the coating 40 to the edges 25a, 26a, 27a can easily be coordinated on an automated system so that the two tasks are performed as essentially one operation. Hence, the present invention reduces the number of steps required to manufacture the transformer 10 in relation to a conventional manufacturing process. This reduction results in a more efficient, less costly, and less time-consuming manufacturing process.

Furthermore, applying the moisture-resistant coating 40 on a automated basis provides the substantial advantages associated with automated processing operations, e.g., reductions in manufacturing time, costs, and labor. In particular, an automated application of a coating such as the moisture-resistant coating 40 typically produces fewer defects and inconsistencies than a comparable manual application.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of the parts, within the principles of the invention to the full extent indicated by the broad general meaning of the terms in which the appended claims are expressed.

For example, although the invention has been described in relation to the stacked-core transformer 10, the invention can also be applied to transformers having wound cores. A wound core typically comprises one or more magnetic loops. Each loop is formed by winding a long, narrow, continuous strip of magnetic material. This strip of material is commonly formed from a larger sheet of material using a suitable technique such as cutting, punching, or shearing. In accordance with the present invention, the newly-formed edges of the strips formed by the cutting, punching, or shearing operation can be coated with a corrosion-protection measure before the strip is wound to form the magnetic loop.

What is claimed is:

1. A method of manufacturing an electrical-power transformer, comprising:
forming a first and a second plurality of laminae from one or more pieces of magnetic material;
applying a corrosion-protection measure to edges of the first and the second pluralities of laminae;
stacking the first plurality of laminae to form a winding leg and a first yoke after applying the corrosion-protection measure to the edges of the first plurality of laminae;
installing a phase winding on the winding leg;
stacking the second plurality of laminae to form a second yoke after applying the corrosion-protection measure to the edges of the second plurality of laminae; and
fixedly coupling the second yoke to the winding leg.

2. The method of claim 1, further comprising fixedly coupling the winding leg to the first yoke after stacking the first plurality of laminae to form the winding leg and the first yoke.

3. The method of claim 1, further comprising stacking the first plurality of lamina to form a first and a second outer leg applying the corrosion-protection measure to the edges of the first plurality of laminae.

4. The method of claim 3, further comprising fixedly coupling the first and the second outer legs to the first yoke after stacking the first plurality of lamina to form the first and the second outer legs.

5. The method of claim 4, further comprising fixedly coupling the second yoke to the first and the second outer legs.

6. The method of claim 1, wherein stacking the second plurality of laminae to form a second yoke after applying the corrosion-protection measure to the edges of the second plurality of laminae comprises stacking the second plurality of laminae to form the second yoke after installing the phase winding on the winding leg.

7. The method of claim 1, wherein forming a first and a second plurality of laminae from one or more pieces of magnetic material comprises cutting the first and the second pluralities of laminae from the one or more pieces of magnetic material.

8. The method of claim 1, wherein forming a first and a second plurality of laminae from one or more pieces of magnetic material comprises shearing the first and the second pluralities of laminae from the one or more pieces of magnetic material.

9. The method of claim 1, wherein forming a first and a second plurality of laminae from one or more pieces of magnetic material comprises punching the first and the second pluralities of laminae from the one or more pieces of magnetic material.

10. The method of claim 1, wherein applying a corrosion-protection measure to edges of the first and the second pluralities of laminae comprises applying a moisture-resistant coating to the edges.

11. The method of claim 1, wherein applying a corrosion-protection measure to edges of the first and the second pluralities of laminae comprises applying epoxy-based paint to the edges.

12. The method of claim 1, wherein applying a corrosion-protection measure to edges of the first and the second pluralities of laminae comprises spraying the corrosion-protection measure onto the edges.

13. The method of claim 1, wherein applying a corrosion-protection measure to edges of the first and the second pluralities of laminae comprises brushing the corrosion-protection measure onto the edges.

14. The method of claim 1, wherein forming a first and a second plurality of laminae from one or more pieces of magnetic material and applying a corrosion-protection measure to edges of the first and the second pluralities of laminae are performed on an automated basis.

15. The method of claim 1, wherein stacking the first plurality of laminae to form a winding leg and a first yoke comprises superposing the first plurality of laminae to a predetermined depth and binding the first plurality of laminae together.

16. The method of claim 1, wherein stacking the second plurality of laminae to form a second yoke comprises superposing the second plurality of laminae to a predetermined depth and binding the second plurality of laminae together.

17. The method of claim 1, wherein the applying a corrosion-protection measure to edges of the first and the second pluralities of laminae comprises applying the corrosion-protection measure to edges of the first and the second pluralities of laminae created by forming the first and the second pluralities of laminae from the one or more pieces of magnetic material.

18. A method of manufacturing a stacked core for a magnetic-induction device, comprising:
forming a plurality of laminae from one or more pieces of magnetic material;
applying a corrosion-protection measure to edges of the laminae; and
stacking the laminae to form a winding leg and a first and a second yoke after applying the corrosion-protection measure.

19. The method of claim 18, further comprising fixedly coupling the winding leg to the first yoke after stacking the laminae to form the winding leg and the first yoke.

20. The method of claim 18, further comprising stacking the laminae to form a first and a second outer leg after applying the corrosion-protection measure.

21. The method of claim 20, further comprising fixedly coupling the first and the second outer legs to the first yoke.

22. The method of claim 21, further comprising fixedly coupling the second yoke to the first and the second outer legs.

23. The method of claim 18, wherein stacking the laminae to form a winding leg and a first and a second yoke comprises superposing the laminae to a predetermined depth and binding the laminae together.

24. The method of claim 18, wherein forming a plurality of laminae from one or more pieces of magnetic material comprises cutting the laminae from the one or more pieces of magnetic material.

25. The method of claim 18, wherein forming a plurality of laminae from one or more pieces of magnetic material comprises shearing the laminae from the one or more pieces of magnetic material.

26. The method of claim 18, wherein forming a plurality of laminae from one or more pieces of magnetic material comprises punching the laminae from the one or more pieces of magnetic material.

27. The method of claim 18, wherein applying a corrosion-protection measure to edges of the laminae comprises applying a moisture-resistant coating to the edges.

28. The method of claim 18, wherein applying a corrosion-protection measure to edges of the laminae comprises applying epoxy-based paint to the edges.

29. The method of claim 18, wherein applying a corrosion-protection measure to edges of the laminae comprises spraying the corrosion-protection measure onto the edges.

30. The method of claim 18, wherein applying a corrosion-protection measure to edges of the laminae comprises brushing the corrosion-protection measure onto the edges.

31. The method of claim 18, wherein forming a plurality of laminae from one or more pieces of magnetic material and applying a corrosion-protection measure to edges of the laminae are performed on an automated basis.

32. The method of claim 17, wherein the applying a corrosion-protection measure to edges of the laminae comprises applying the corrosion-protection measure to edges of the laminae created by forming the laminae from the one or more pieces of magnetic material.

33. The method of claim 18, further comprising fixedly coupling the second yoke to the winding leg.

34. A method of manufacturing a wound core for a magnetic-induction device, comprising:
forming a strip of magnetic material from a piece of magnetic material;
applying a corrosion-protection measure to edges of the strip of magnetic material; and
winding the strip of magnetic material after applying the corrosion-protection measure to form a magnetic loop.
